(19) United States
(12) Patent Application Publication
(10) Pub. No.: US 2018/0131251 A1
(43) Pub. Date: May 10, 2018

(54) ROTOR OF A GEARLESS WIND TURBINE

(71) Applicant: Wobben Properties GmbH, Aurich (DE)

(72) Inventors: Jochen RÖER, Ganderkesee (DE); Jan Carsten ZIEMS, Aurich (DE)

(73) Assignee: Wobben Properties GmbH, Aurich (DE)

(21) Appl. No.: 15/571,466

(22) PCT Filed: Apr. 29, 2016
(86) PCT No.: PCT/EP2016/059628

§ 371 Date: Nov. 2, 2017

(30) Foreign Application Priority Data
May 7, 2015 (DE) 10 2015 208 553.8

(51) Int. Cl. H02K 7/18; F03D 9/25; F03D 80/80; H02K 3/18; H02K 19/26; H02K 19/38

(52) U.S. Cl. CPC H02K 7/1838; F03D 9/25; F03D 80/82; F03D 1/065; H02K 19/26; H02K 19/38; H02K 3/18

(57) ABSTRACT

A preformed coil of a rotor of a synchronous generator of a gearless wind power plant is provided. The preformed coil may be arranged around a pole shoe defining a central axis. The preformed coil has a plurality of windings and is made up of laminations.

### BACKGROUND

### Technical Field

The present invention relates to a preformed coil of a rotor of a synchronous generator of a gearless wind turbine. Moreover, the present invention relates to a generator having a preformed coil of this kind, and the present invention relates to a wind turbine having a generator of this kind. The present invention furthermore relates to a method for producing a preformed coil.

### Description of the Related Art

Wind turbines are known and have a generator. Modern and robust wind turbines use a gearless concept, in which the generator is driven directly by the aerodynamic rotor of the wind turbine, without the interposition of a gear. A generator of this kind is also referred to as a generator of a gearless wind turbine. Generators of this kind are characterized by large air gap diameters. Such air gap diameters can be up to 10 m, as is the case, for example, with a type E-126 ENERCON wind turbine. Air gap diameters of 4 to 5 m are common in the case of gearless wind turbines.

Moreover, such generators of gearless wind turbines are of multi-pole design and, in particular, can be designed as ring-type generators, in which the electrically and magnetically active elements are present essentially only in an annular region around the air gap.

In order to build up a magnetic field in the rotor without using permanent magnets, an excitation winding is provided for each rotor pole or each pole shoe in order to produce the magnetic field by means of an appropriate electrical excitation. A generator of this kind or a synchronous machine of this kind can also be referred to as a separately excited generator or separately excited synchronous machine. In addition, the term “rotor” is used below to refer to the rotor of the generator, unless indicated otherwise.

In order to generate the magnetic field, a corresponding excitation current is required and, particularly in rated operation, this can also lead to heating both of the corresponding excitation winding and of the corresponding pole shoe. One significant reason for this heating is the production of Joule heat in the excitation windings, of which there are a number in separately excited gearless wind turbines. This heating can be considerable although the windings generally have a comparatively low resistance owing to the use of copper. In addition, there is the fact that such copper windings can generally have between them interspaces which at least hinder heat transfer and hence heat dissipation. Moreover, this concept can be fairly expensive for a gearless wind energy plant, depending on the price of copper, because quite a lot of copper is required. On the other hand, there are virtually no materials with a better conductivity than copper, at least among the materials that are available on an industrial scale.

In addition, there is the fact that the separate excitation concept described can furthermore be made expensive by the fact that the pole shoes, together with their windings, are dipped in a corresponding insulation bath for the purpose of insulation, this often being carried out in such a way that the entire fully equipped rotor is dipped. Apart from the problem that the insulation thereby applied often hinders heat transfer and hence heat dissipation, it is also expensive to dip a complete rotor of this kind in a corresponding insulation bath.

### BRIEF SUMMARY

Disclosed is a solution which is less expensive and/or thermally more efficient, in particular one which allows better heat dissipation. At the very least, proposed herein is an alternative solution to the previously known solutions.

A preformed coil is proposed. Thus, a preformed coil of a rotor of a synchronous generator of a gearless wind turbine for arrangement around a pole shoe defining a central axis is proposed. This use of a preformed coil on a pole shoe of a rotor implies that it relates to a separately excited synchronous generator. Thus, the preformed coil is to be arranged around the pole shoe. In this arrangement, the preformed coil is then the excitation winding of this pole shoe and generates a magnetic field, which is guided in the pole shoe and runs substantially parallel to a central axis of the pole shoe.

Here, the preformed coil has a plurality of windings and is made up of laminations. Thus, the windings are made up of laminations.

Accordingly, preformed coils are in each case made up of laminations in this gearless synchronous generator. By this means, it is possible, inter alia, to ensure that said laminations of each winding rest flat one upon the other and hence that improved heat transfer to adjacent laminations can take place if temperatures differ in the layering direction. Moreover, heat transfer can also take place relatively easily within each lamination because there are no thermally insulating interspaces there. Here, heat transfer can take place radially outward in a particularly direct way.

Moreover, the use of laminations enables the shape thereof and hence the overall shape of the preformed coil to be well predefined and also influenced in other respects.

These laminations are preferably layered in the axial direction of the pole shoe, i.e., in an axial direction with respect to the central axis of the pole shoe. In particular, they are layered exclusively in this axial direction of the pole shoe, i.e., have just one lamination in each plane and not several laminations adjacent to one another. Starting from the pole shoe or the central axis thereof, there is thus no interruption in the preformed coil in a radial direction because, if the laminations are layered only in an axial direction, each lamination extends radially from the pole shoe as far as the outside. Accordingly, heat in each layer can be dissipated radially outward to the radially outer edge of the preformed coil. Heat transfer and hence, as a result, a cooling process can thereby be configured in an advantageous way.

According to one embodiment, it is proposed that the laminations are configured in such a way that the preformed coil has surfaces that are larger in comparison with flat surfaces, in particular corrugated or ribbed surfaces due to beveled edges of the laminations and/or due to different widths of adjacent laminations. This relates to surfaces which face away from the pole shoe, i.e., surfaces which are oriented radially outward relative to the pole shoe or the central axis thereof. These surfaces can also be referred to as outer surfaces. In particular, this can relate to surfaces which together form a substantially encircling outer circumferential surface of the preformed coil. In this region, the laminations can thus be provided with beveled edges. If these laminations with the beveled edges are then stacked or layered one on top of the other to form the preformed coil, these beveled edges come together to form a corrugated surface. In addition or as an alternative, it is possible to provide laminations of different widths, in particular with alternating differences in width. If these are layered one on top of the other, each second lamination thus protrudes and thereby forms a rib structure or rib shape and hence forms a ribbed surface there.

In both cases presented by way of example, the result is an increased overall outer surface area of the preformed coil. Especially if, in addition, each lamination extends continuously from the pole shoe to this corrugated or ribbed surface, heat can be transferred there comparatively easily and can be released more easily by radiation at this enlarged surface. There is also the fact that the design provided is one in which a cooling medium, such as an air flow, flows along these corrugations or ribs in order thereby to dissipate the heat there.

According to another embodiment, it is proposed that the preformed coil in each case has a winding or a half winding consisting of one lamination, and these laminations are assembled to form the plurality of windings of the preformed coil. In the event that a half winding consists of a lamination or is made available therefrom, a preferred proposal is that such a lamination is approximately L-shaped. This has the particular advantage that such laminations can be punched out with very little waste. It is possible, in particular, for two identical L shapes to be placed together to form a rectangle or to be punched out in a rectangular shape.

In this way, it is possible to prepare a lamination plane-by-plane, or two laminations are prepared plane-by-plane. A lamination of this kind can thus be formed essentially from a flat sheet. Another option to be considered is that of punching the corresponding laminations out of a large overall sheet or cutting them out from said sheet by laser cutting, for example. Particularly when using a large number of L-shaped laminations, these can be cut out with very little waste. These individual laminations then only need to be connected. This can be accomplished by welding or soldering, for example, and, in both these examples mentioned, this also results in a joint with a high electrical conductivity. In addition or as an alternative, a positive-locking joint, e.g., a “dovetail” joint, in which one of two parts to be joined has a projection approximately in the form of a dovetail and the other part has a corresponding dovetail recess, can preferably be provided.

The laminations are thus cut out or punched out particularly in such a way that this shape cut out or punched out in this way is matched to the pole shoe which the preformed coil and hence each winding concerned is supposed to surround. That this winding is laid around this pole shoe is thus not accomplished by bending the material around this pole shoe; instead, this shape is punched out in this way and no longer needs to be bent. This makes it possible to form virtually any desired shape around this pole shoe. In particular, it is possible in this way for windings produced from laminations to be constructed and laid closely even around sharp edges. By virtue of the principle involved, problems which could occur in the material when bending around such sharp corners or edges are thereby avoided.

According to a preferred embodiment, the laminations are manufactured from aluminum. Aluminum has poorer conductivity than copper but weighs less. It is thus possible, for example, for the structural shape of the rotor or of the pole shoes thereof together with the preformed coils, which can also be referred to as pole shoe coils, to be enlarged somewhat. It would thereby be possible to create a rotor, the electrical behavior of which is similar to that of a rotor with copper coils, while taking up somewhat less installation space. Such a design using aluminum would then nevertheless be lighter than the comparable copper solution with a smaller overall volume. Moreover, it could be expected that such an aluminum solution would also be cheaper than the copper solution described by way of comparison. Thus, surprisingly, the situation can be improved by using aluminum, even though aluminum is a poorer conductor than copper.

According to one embodiment, the laminations are manufactured from copper, in particular in order to exploit the good conductivity of copper.

The preformed coil is preferably characterized in that it has been dipped in a bath containing an insulating varnish, in particular without the pole shoe and without other winding bodies, for the purpose of insulation. During this process, other qualities of a preformed coil also prove their worth, namely that it can have a high mechanical stability without the pole shoe. For insulation, it can therefore be dipped into a bath containing an insulating varnish without being mounted on the pole shoe. In particular, this dipping operation is possible without the need to dip the entire rotor. This dipping, in particular separate dipping, of the preformed coil is also apparent namely from the fact that the insulating varnish wets the laminations of the preformed coil uniformly at all points and covers it in a correspondingly uniform manner after hardening. The preformed coil is preferably dipped in a slightly spread-apart state by ensuring at least a small spacing between the planes of laminations so that the insulating varnish also gets between the laminations.

The proposal is furthermore made for a generator which is provided for a gearless wind turbine and has a rotor with preformed coils that are designed in the manner described above in connection with at least one embodiment.

A wind turbine having a synchronous generator of this kind is furthermore proposed.

A method for producing a preformed coil is furthermore proposed.

According to this, the laminations, in particular two laminations, are first of all cut or punched out of a large sheet. These laminations are then connected to form one or more windings, according to the form in which the laminations are present and to the number thereof. In particular, the number of laminations punched or cut out is sufficient to allow the complete winding of the preformed coil to be produced.

For example, the procedure followed can be such that 40 L-shaped laminations are punched or cut out for a preformed coil having a winding with 20 turns. These L-shaped laminations are then gradually assembled and connected, e.g., welded or soldered, in order thereby to form this assembled winding. In particular, two L-shaped laminations in each case are connected in a sub-step to form a winding in this example. If appropriate, the first and fortieth laminations differ from the other 38 laminations because these two laminations must be provided with corresponding connections. Otherwise, it can also be assumed that the complete winding essentially forms the preformed coil. Here, a verbal distinction is made between these two elements primarily because the winding can also represent an intermediate state on the way to the finished preformed coil, e.g., a preformed coil without insulating varnish.

Accordingly, it is also proposed to dip the winding produced in this way in a bath containing an insulating varnish in order thereby to insulate this winding, more specifically also the individual turns and hence the individual laminations from one another, naturally with the exception of the connection point, although consideration may also be given here to removing the applied insulating varnish again.

A method for producing a pole shoe provided with a preformed coil is furthermore proposed. According to this, a preformed coil according to at least one of the embodiments described is first of all produced or made available. For this purpose, production can be carried out in accordance with a production method described according to at least one of the embodiments.

The preformed of coil is then mounted or pushed onto the pole shoe, and the preformed coil thus assembled, with the pole shoe, is then filled, in particular with synthetic resin. Here, conventional synthetic resin, which is also used in other cases for dipping or filling coils or transformers, can be used.

It is thereby possible to fasten this preformed coil well and firmly and in a comparatively simple manner on the pole shoe. This solves the problem that conventional winding does not give a firm joint.

During this process, a preformed coil made from aluminum is preferably used, and this can be well fastened by means of the production and connection method described. At the same time, account is also taken of the fact that aluminum expands more with temperature than copper and furthermore also significantly more than the core on which in this case it is supposed to be seated on the pole shoe.

In addition or as an alternative, it is proposed that the preformed coil is dimensioned in such a way that it can be placed or pushed onto the pole shoe loosely with a certain amount of play. Here too, account is taken of the different expansion coefficients and, by virtue of this slightly larger dimensioning of the preformed coil, a correspondingly slightly larger interspace between the preformed coil and the pole shoe is obtained. This is then filled with resin in the manner described and, accordingly, more resin is used and, where applicable, this can thus provide compensation that could become necessary owing to the different temperature coefficients mentioned.

### BRIEF DESCRIPTION OF THE SEVERAL VIEWS OF THE DRAWINGS

The invention is now explained in greater detail below by way of example with reference to the attached figures.

FIG. 1 shows a wind turbine in a perspective illustration.

FIG. 2 shows schematically two L-shaped laminations for a preformed coil.

FIG. 3 shows a preformed coil or winding of a preformed coil consisting of laminations as shown in FIG. 2, in a perspective and schematic illustration.

FIGS. 4 and 5 illustrate different corrugated surfaces in a side view to illustrate the contours.

FIG. 6 shows part of a winding of a preformed coil in a perspective illustration.

FIG. 7 shows a detail of a generator arranged in a nacelle.

### DETAILED DESCRIPTION

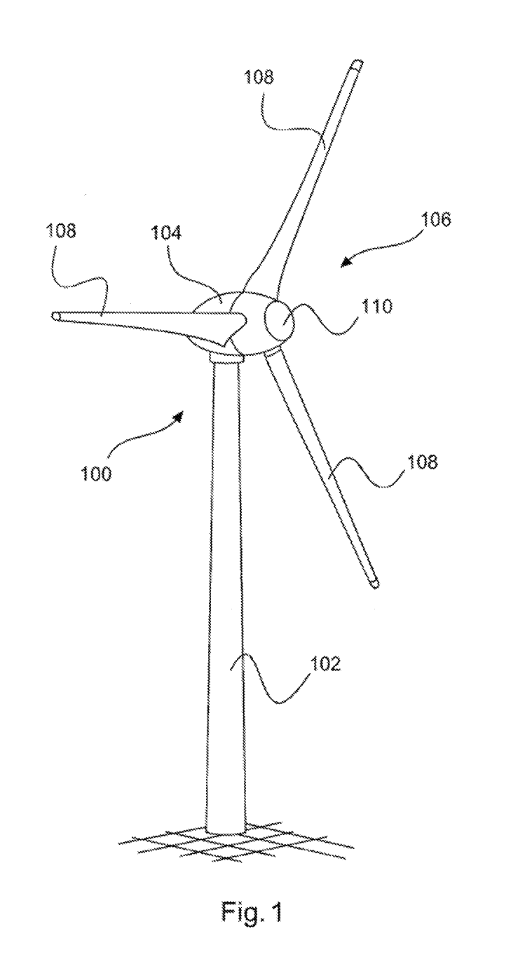

FIG. 1 shows a wind turbine 100 having a tower 102 and a nacelle 104. A rotor 106 having three rotor blades 108 and a spinner 110 is arranged on the nacelle 104. In operation, rotation is imparted by the wind to the rotor 106, which thereby drives a generator in the nacelle 104.

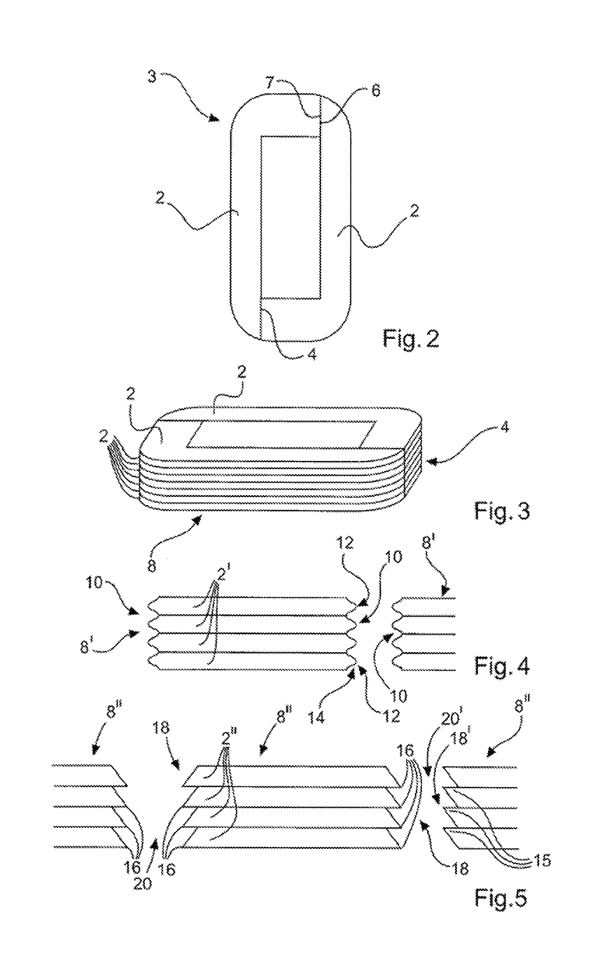

FIG. 2 shows a plan view of two L-shaped laminations 2. These two L-shaped laminations 2 can be identical in shape and are connected to one another at the connecting joint 4 to form a winding 3. It is thereby possible to avoid overlaps from one winding to the next. At further connecting edges 6 and 7, the two L-shaped laminations 2 can be connected to other laminations, namely at a higher or lower level or plane, to produce a preformed coil, although this is not shown here in FIG. 2.

FIG. 3 then shows schematically a finished winding 8, which is made up of eight layers and hence 16 L-shaped laminations 2 according to FIG. 2. The winding 8 thus essentially already forms a preformed coil.

FIG. 4 shows four layers of a winding 8′ in a side view, which corresponds to a view from the right of the winding 8 shown in FIG. 3. However, no connecting joint 4 is shown in FIG. 4 or in FIG. 5 either. Instead, FIG. 4 is intended to illustrate the outer surface 10 by showing its contours. This outer surface 10 is formed by edges of the individual laminations 2′, which have a curved edge 12 due to a pressing operation. The layering of these laminations 2′ with their curved edges 12 leads to the corrugated surface 10 shown, of which the contours are shown in FIG. 4 by virtue of the perspective selected.

FIG. 4 also shows a detail of a winding 8′, an air channel 14 is formed between these two windings 8′, the side walls of said channel being defined by the contours of the outer surfaces 10.

Thus, on the one hand, it is ensured that the surface area of the outer surface 10 is enlarged by the curved edges 12 and, furthermore, that an air channel 14 with guide grooves or guide slots is obtained.

FIG. 5 shows an alternative embodiment of the laminations 2″. These laminations 2″ have cut edges 16, which thus also lead to an outer surface 18 with an enlarged surface area.

In addition to a sub-winding 8″, two further sub-windings 8″ are shown in the detail. The illustration thereof in FIG. 5 is merely intended to illustrate various possibilities for resulting air channels 20 and 20′. In the case of air channel 20, i.e., that illustrated on the left in FIG. 5, the cut edges 16 are oriented in the same direction on both sides of air channel 20 and thereby give air channel 20 its shape.

In the air channel 20′ illustrated on the right, the adjacent cut edges 16 and 16′ are aligned in the opposite direction, which has no effect on the size of the outer surface 18 or 18′ but affects the shape of the air channel 20′.

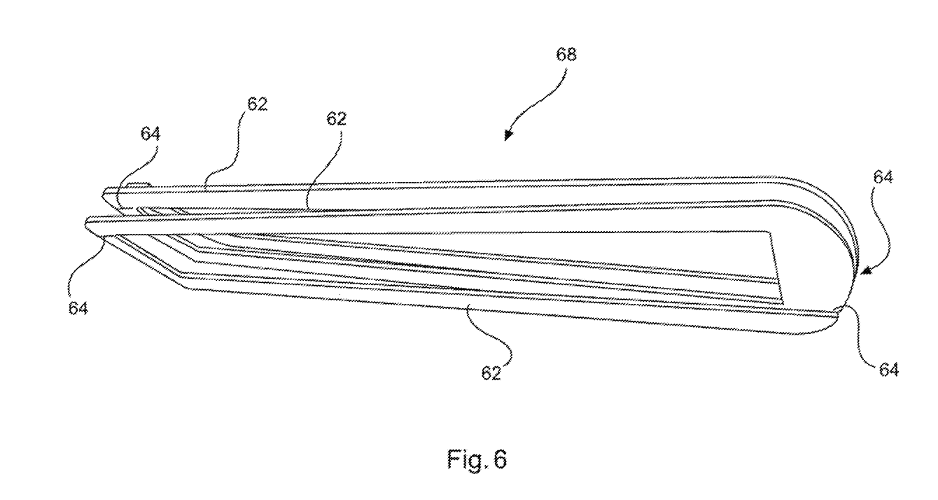

Finally, FIG. 6 shows, in a perspective view, part of a winding 68, which is assembled from five L-shaped laminations 62, in each case at connecting joints 64. The winding 68 or sub-winding 68 in FIG. 6 is furthermore shown somewhat spread apart. In this position, this sub-winding 68 can be dipped effectively into a bath of insulating varnish. However, this is shown here only by way of illustration, and such an insulation dipping process is preferably proposed only for a complete winding, i.e., when further laminations 62 have been added.

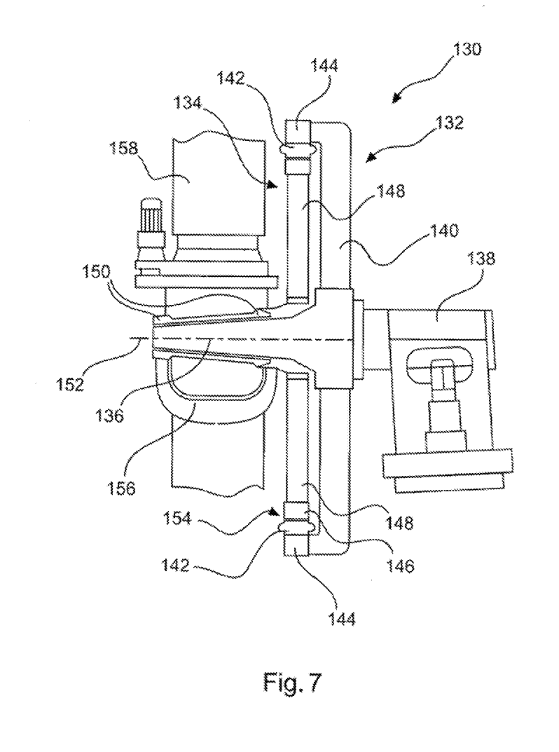

FIG. 7 shows a generator 130 schematically in a side view. It has a stator 132 and an electrodynamic rotor 134, which is mounted so as to be rotatable relative thereto, and is secured by means of its stator 132 on a machine support 138 using an axle journal 136. The stator 132 has a stator support 140 and stator lamination assemblies 142, which form stator poles of the generator 130 and are secured on the stator support 140 using a stator ring 144. The electrodynamic rotor 134 has rotor pole shoes 146, which form the rotor poles and are mounted on the axle journal 136 using a rotor support 148 and bearings 150 so as to be rotatable about the axis of rotation 152. The stator lamination assemblies 142 and rotor pole shoes 146 are separated only by a narrow air gap 154, which is a few mm wide, in particular less than 6 mm, but has a diameter of several meters, in particular more than 4 m. The stator lamination assemblies 142 and the rotor pole shoes 146 each form a ring and are also annular together, and therefore the generator 130 is a ring-type generator. In accordance with its purpose, the electrodynamic rotor 134 of the generator 130 rotates together with the rotor hub 156 of the aerodynamic rotor, of which the initial sections of rotor blades 158 are indicated.

A preformed coil made up of assembled laminations is proposed. This preformed coil can also be referred to as a pole shoe coil. Such pole shoe coils consisting of complete or half windings cut from metal sheets, are preferably joined together by means of suitable connection techniques. A laminated coil is thus obtained. Welding, e.g., friction stir welding, and soldering are particularly suitable connection techniques because it is thereby possible to produce the required electrically conducting joint.

Laser cutting, water cutting and punching, for example, are suitable cutting techniques for consideration. In the case of cutting, half windings have the advantage that they can be cut in an L shape or as similarly as possible from sheets and, as a result, involve very little waste.

When using complete windings, there is the advantage in comparison with half windings that only half as many joints are required, whereas there is considerably more waste when cutting to size.

One significant advantage is providing improved cooling of the pole shoe coils in comparison to coils wound from wire. In particular, this is achieved by virtue of the fact that the heat can flow directly to the coil surface in each winding of the proposed solution. In contrast to coils that are wound edgeways, that is to say in which sheets or similar conductive materials are arranged with the surface around the central axis and not perpendicularly to the central axis, cut laminated coils can be produced in any desired two dimensional geometry and therefore do not require any bending gradients. Otherwise, however, coils that are wound edgeways could have similar advantages as regards heat flux as the solution proposed here.

For the preformed coils or laminated coils or pole shoe coils proposed, where these terms can be used synonymously, copper but also aluminum are suitable. Here, aluminum is preferably proposed for reasons already explained above.

It is furthermore proposed that the coils can be given contours suitable for cooling by means of suitable cutting tools or suitable aftertreatment. For example, the coils can be cut obliquely at the outer edge, giving rise to a zigzag surface at the outer surface of the coil through windings lying one above the other. The surface area enlarged in this way leads to increased heat transfer to the cooling medium, which is generally air between the poles. The individual windings of sheet metal can likewise be pressed into a shape such that a cooling tab or cooling rib of suitable geometry is formed at the outer edges, for example.

Thus, better cooling of the coils is achieved, in particular. By virtue of the very good heat flux within the conductor material, i.e., from the inside outward within the laminations of a winding, the heat produced can be dissipated directly at the coil surface.

Apart from dipping the winding produced from the laminations, the use of pre-insulated laminations can also be considered. However, re-insulation would then have to be performed at weld seams.

Moreover, not only are good thermal conductivity and heat dissipation obtained but also a somewhat better filling factor in comparison with conventionally wound coils is obtained with the solution proposed.

The solution proposed can furthermore lead to a larger or taller winding head, but there is generally sufficient space for this in a generator of a gearless wind turbine. Any increase in magnetic losses which occurs can easily be compensated for by one or two further windings.

1. A preformed coil of a rotor of a synchronous generator of a gearless wind turbine, the preformed coil comprising:
a plurality of windings, a winding of the plurality of windings being made up of one or more laminations, and the preformed coil being operable to be arranged around a pole shoe having a central axis.

2. The preformed coil according to claim 1, wherein the plurality of windings are layered in an axial direction along the central axis of the pole shoe.

3. The preformed coil according to claim 1, wherein the laminations are configured such that the preformed coil has outward surfaces that are larger compared to flat surfaces.

4. The preformed coil according to claim 1, wherein the winding of the plurality of windings or a half of the winding consists of one lamination, and the one or more laminations of the winding of the plurality of windings are assembled together with laminations of remaining windings of the plurality of windings to form the preformed coil.

5. The preformed coil according to claim 1, wherein the one or more laminations are aluminum or copper.

6. The preformed coil according to claim 1, wherein the preformed coil is dipped in a bath including an insulating varnish for insulating the preformed coil.

7. The preformed coil according to claim 1, wherein the winding of the plurality of windings includes two L-shaped laminations connected to each other by a connecting joint form the winding, and wherein the two L-shaped laminations have an identical shape.

8. A synchronous generator of the gearless wind turbine, the synchronous generator comprising a rotor with at least one preformed coil according to claim 1.

9. A wind turbine comprising the synchronous generator according to claim 8.

10. A method comprising:
punching or cutting out at least two laminations, and
connecting the at least two laminations to form one or more windings of a preformed coil.

11. The method according to claim 10, comprising:
after connecting the at least two laminations, dipping the one or more windings in a bath containing an insulating varnish.

12. The method according claim 10 further comprising:
placing the preformed coil on a pole shoe, and
filling interspaces between the preformed coil and the pole shoe.

13. The method according to claim 12, comprising:
making the preformed coil from aluminum, and
dimensioning the preformed coil such that the preformed coil is positioned loosely on the pole shoe with an amount of clearance.

14. The method according to claim 10, comprising connecting the at least two laminations to form a complete winding of the preformed coil.

15. The method according to claim 12, comprising:
filling the interspaces between the preformed coil and the pole shoe with synthetic resin.

16. The preformed coil according to claim 2, wherein the windings are layered exclusively in the axial direction of the pole shoe.

17. The preformed coil according to claim 3, wherein the one or more laminations have beveled edges.

18. The preformed coil according to claim 17, wherein the outward surfaces are corrugated or ribbed due to the beveled edges of the one or more laminations.

19. The preformed coil according to claim 3, wherein two or more adjacent laminations of two or more adjacent windings have different widths.

20. The preformed coil according to claim 19, wherein the outward surfaces are corrugated or ribbed due to the two or more adjacent laminations of the two or more adjacent windings having different widths.

21. The preformed coil according to claim 6, wherein the preformed coil is dipped in the bath including the insulating varnish without the pole shoe.
